(19) United States
(12) Patent Application Publication
(10) Pub. No.: US 2026/0254472 A1
(43) Pub. Date: Aug. 27, 2026

(54) FAST GAIN-DEPENDENT MIX DC OFFSET CALIBRATION CIRCUIT, METHOD, AND ZERO-IF RECEIVER

(71) Applicants: Chongqing GigaChip Technology Co., Ltd., Chongqing (CN); NO.24 RESEARCH INSTITUTE OF CHINA ELECTRONICS TECHNOLOGY GROUP CORPORATION, Chongqing (CN)

(72) Inventors: Youhua WANG, Chongqing (CN); Jiarui OU, Chongqing (CN); Cong ZHANG, Chongqing (CN); Yongshuang LUO, Chongqing (CN); Ji DONG, Chongqing (CN); Maojia XU, Chongqing (CN); Bai LI, Chongqing (CN); Jialin FAN, Chongqing (CN); Xincong WANG, Chongqing (CN); Qianchen LEI, Chongqing (CN); Fusen YANG, Chongqing (CN); Zhuonan YAO, Chongqing (CN); Can ZHU, Chongqing (CN); Dongbing FU, Chongqing (CN); Zhou YU, Chongqing (CN); Zhengping ZHANG, Chongqing (CN); Jianan WANG, Chongqing (CN); Kairang CHEN, Chongqing (CN)

(73) Assignees: Chongqing GigaChip Technology Co., Ltd., Chongqing (CN); NO.24 RESEARCH INSTITUTE OF CHINA ELECTRONICS TECH, Chongqing (CN)

(21) Appl. No.: 19/641,571

(22) Filed: Apr. 8, 2026

Related U.S. Application Data
(63) Continuation of application No. PCT/CN2025/105406, filed on Jun. 30, 2025.

(30) Foreign Application Priority Data
Feb. 24, 2025 (CN) 202510204535.9

(51) Int. Cl. H04B 1/30; H04B 1/40

(52) U.S. Cl. CPC H04B 1/30; H04B 2001/305; H04B 1/40

(57) ABSTRACT

A fast gain-dependent mix DC offset calibration circuit includes: a DC offset calibration controller, a mix DC offset calibrator, and a digital-domain DC offset calibrator. The DC offset calibration controller is configured to output a first control signal to start the mix DC offset calibrator based on state information sent by a state controller of the zero-IF receiver. The mix DC offset calibrator is configured to execute a mix DC offset calibration algorithm to perform mix DC offset calibration and obtain a calibration codeword when the first control signal is at a first value. The digital-domain DC offset calibrator is configured to execute a digital-domain DC offset calibration algorithm when the first control signal is at a second value, and perform digital-domain DC calibration based on the calibration codeword.

### CROSS REFERENCE TO RELATED APPLICATION

The present disclosure is a continuation application of International Patent Application No. PCT/CN2025/105406, filed on Jun. 30, 2025, and claiming the priority to Chinese Application No. 2025102045359 filed on Feb. 24, 2025, the contents of all of which are incorporated herein by reference in their entirety for all purposes.

### TECHNICAL FIELD

The present application relates to the technical field of a single-chip radio-frequency (RF) transceiver system-on-chip (SoC) integrated circuit, specifically to a gain-dependent fast mix direct current (DC) offset calibration circuit, method, and zero intermediate-frequency (zero-IF) receiver.

### BACKGROUND

Due to its advantages such as single frequency conversion and ease of integration, on-chip zero-IF receivers have become a research hotspot with the rapid development of integrated circuits. An on-chip zero-IF receiver includes a mixer, a low-pass filter, a digital-to-analog converter, and a digital signal processing path, and other units.

### SUMMARY

The present application provides a fast gain-dependent mix DC offset calibration circuit, method, and zero-IF receiver.

The present application provides a gain-dependent DC offset calibration circuit for use in a zero-IF receiver. The calibration circuit includes: a DC offset calibration controller, a mix DC offset calibrator, and a digital-domain DC offset calibrator.

The DC offset calibration controller is configured to output a first control signal enable_mix based on state information rx_state sent by a state controller of the zero-IF receiver, to start the mix DC offset calibrator.

The mix DC offset calibrator is configured to execute a mix DC offset calibration algorithm to perform mix DC offset calibration when the first control signal enable_mix is at a first value, to obtain a calibration codeword.

The digital-domain DC offset calibrator is configured to execute a digital-domain DC offset calibration algorithm when the first control signal enable_mix is at a second value, and perform digital-domain DC calibration according to the calibration codeword.

In an embodiment of the present application, the DC offset calibration circuit further includes a DC offset calibration DAC.

The mix DC offset calibrator is configured to output a codeword mix_code when the first control signal enable_mix is at the first value, and send the codeword mix_code into the DC offset calibration DAC.

The DC offset calibration DAC is configured to convert the codeword mix_code from a digital codeword to an analog current, wherein the analog current output by the DC offset calibration DAC is added to the output current of a mixer, and a digital codeword is obtained after the combined output current passes through a low-pass filter, an ADC, and a digital filter.

The mix DC offset calibrator detects a DC value based on the digital codeword and generates a corresponding calibration codeword.

In an embodiment of the present application, the calibration circuit further includes: a memory configured to store the calibration codeword and a link sequence gain_index[i] configured by a gain controller of the zero-IF receiver as an association.

In an embodiment of the present application, during mix DC calibration, the mix DC offset calibrator outputs a second control signal lock_mix to indicate whether the mix DC calibration is completed.

When the second control signal lock_mix is at the first value, it is indicated that the mix DC calibration is complete.

When the second control signal lock_mix is at the second value, it is indicated that the mix DC calibration has not been completed.

In an embodiment of the present application, the mix DC offset calibrator includes: a first-stage accumulation unit; a gain unit; and a second-stage accumulation unit.

The number of accumulated points in the first-stage accumulation unit is N_{A}, and an output signal Aᵢ of the gain unit is:

$${A}_{i} = {k}_{a t t} {\sum }_{n = 1}^{{N}_{A}} {x}_{i} [ n ] , \qquad ( 1 )$$

where katt is a gain of the gain unit, xᵢ[n] represents an i-th accumulation interval of a signal x[n] output by the digital filter,
a DC offset value of the signal does not change within the accumulation interval, and the signal x[n] is expressed as:

$$x [ n ] = a sin ( 2 π f n ) + d , \qquad ( 2 )$$

where a represents signal amplitude, f represents signal frequency, and d is a DC component of the signal;
in the i-th accumulation interval, the signal xᵢ[n] is:

$${x}_{i} [ n ] = {a}_{i} sin ( 2 π fn ) + d - {k}_{c o n v} {d}_{c o m p , i} = {a}_{i} sin ( 2 π fn ) + {d}_{i} , \qquad ( 3 )$$

where aᵢ represents signal amplitude, d_{comp, i} represents the calibration codeword, and k_{conv} is the gain coefficient;
the output value Aᵢ of the gain unit is a current DC offset value of the signal:

$${A}_{i} = {k}_{a t t} \times {\sum }_{n = 1}^{{N}_{A}} {x}_{i} [ n ] \approx {k}_{a t t} {d}_{i} {N}_{A} , \qquad ( 4 )$$

the second-stage accumulation unit receives the output value Aᵢ from the gain unit and obtains a next update value d_{comp,i+1}:

$${d}_{comp , i + 1} = {d}_{comp , i} + {k}_{a t t} {d}_{i} {N}_{A} , \qquad ( 5 )$$

substituting dᵢ=d−k_{conv}×d_{comp,i} into the above equation to get:

$${d}_{comp , i + 1} = {d}_{c o m p , i} + {k}_{att} {N}_{A} ( d - {k}_{c o n v} {d}_{comp , i} ) = {k}_{att} {N}_{A} d + ( 1 - {k}_{c o n v} {k}_{att} {N}_{A} ) {d}_{comp , i} = A + k {d}_{c o m p , i} , \qquad ( 6 )$$

$$\begin{matrix}k = 1 - {k}_{c o n v} {k}_{a t t} {N}_{A} \\ A = {k}_{a t t} {N}_{A} d\end{matrix} , \qquad ( 7 )$$

and equation (7) reduces or eliminates the DC offset value in the signal after multiple iterations.

To achieve the above and other objectives, the present application provides a gain-dependent DC offset calibration method applied to a zero-IF receiver. The zero-IF receiver includes a gain controller and a state controller; the calibration method includes: a DC offset calibration controller outputting a first control signal enable_mix based on state information rx_state sent by a state controller of the zero-IF receiver, to start a mix DC offset calibrator; when the first control signal enable_mix is at a first value, a mix DC offset calibrator executing a mix DC offset calibration algorithm to perform mix DC offset calibration to obtain a calibration codeword; and when the first control signal enable_mix is at a second value, a digital-domain DC offset calibrator executing a digital-domain DC offset calibration algorithm to perform digital-domain DC calibration according to the calibration codeword.

In an embodiment of the present application, when the first control signal enable_mix is at the first value, the mix DC offset calibrator executes the mix DC offset calibration algorithm to perform mix DC offset calibration to obtain the calibration codeword includes: when the first control signal enable_mix is at the first value, the mix DC offset calibrator outputting a codeword mix_code and sending the codeword mix_code to the DC offset calibration DAC; converting, by the DC offset calibration DAC, the codeword mix_code from a digital codeword to an analog current, adding, by the DC offset calibration DAC, the analog current to an output current of a mixer, and obtaining a digital codeword after the output current passes through a low-pass filter, an ADC and a digital filter; and the mix DC offset calibrator detecting a DC value based on the digital codeword and generating a corresponding calibration codeword.

In an embodiment of the present application, the calibration method further includes: storing the calibration codeword and a link sequence gain_index[i] configured by the gain controller of the zero-IF receiver as an association.

In an embodiment of the present application, the mix DC offset calibrator includes: a first-stage accumulation unit, a gain unit, and a second-stage accumulation unit; the mix DC offset calibrator detecting the DC value based on the digital codeword and generating the corresponding calibration codeword includes:
the number of accumulated points in the first-stage accumulation unit being N_{A}, and an output signal Aᵢ of the gain unit being:

$${A}_{i} = {k}_{a t t} {\sum }_{n = 1}^{{N}_{A}} {x}_{i} [ n ] , \qquad ( 1 )$$

where katt is a gain of the gain unit, xi[n] represents an i-th accumulation interval of a signal x[n] output by the digital filter;
assuming that a DC offset value of the signal does not change within the accumulation interval, and the signal x[n] being expressed as:

$$x [ n ] = a sin ( 2 π fn ) + d , \qquad ( 2 )$$

where a represents signal amplitude, f represents signal frequency, and d is a DC component of the signal;
in the i-th accumulation interval, the signal xᵢ[n] being:

$${x}_{i} [ n ] = {a}_{i} sin ( 2 π fn ) + d - {k}_{conv} {d}_{comp , i} = {a}_{i} sin ( 2 π fn ) + {d}_{i} , \qquad ( 3 )$$

where aᵢ represents signal amplitude, d_{comp, i} represents the calibration codeword, and k_{conv} is the gain coefficient;

the output value Aᵢ of the gain unit being a current DC offset value of the signal:

$${A}_{i} = {k}_{a t t} \times {\sum }_{n = 1}^{{N}_{A}} {x}_{i} [ n ] \approx {k}_{a t t} {d}_{i} {N}_{A} , \qquad ( 4 )$$

the second-stage accumulation unit receiving the output value Aᵢ from the gain unit and obtaining a next update value d_{comp,i+1}:

$${d}_{comp , i + 1} = {d}_{comp , i} + {k}_{a t t} {d}_{i} {N}_{A} , \qquad ( 5 )$$

substituting dᵢ=d−k_{conv}×d_{comp,i} into the above equation to get:

$${d}_{comp , i + 1} = {d}_{c o m p , i} + {k}_{att} {N}_{A} ( d - {k}_{c o n v} {d}_{comp , i} ) = {k}_{att} {N}_{A} d + ( 1 - {k}_{c o n v} {k}_{att} {N}_{A} ) {d}_{comp , i} = A + k {d}_{c o m p , i} , \qquad ( 6 )$$

$$\begin{matrix}k = 1 - {k}_{c o n v} {k}_{a t t} {N}_{A} \\ A = {k}_{a t t} {N}_{A} d\end{matrix} , \qquad ( 7 )$$

and equation (7) reducing or eliminating the DC offset value in the signal after multiple iterations.

The present application provides a zero-IF receiver, including a mixer, a low-pass filter, an ADC, a digital filter, a gain controller, and a state controller; the zero-IF receiver also includes the aforementioned DC offset calibration circuit.

It should be understood that the above general description and the following detailed description are exemplary and explanatory only, and do not limit the present application.

### BRIEF DESCRIPTION OF DRAWINGS

The accompanying drawings, which are incorporated in and form part of this specification, illustrate embodiments consistent with the present application and, together with the description, serve to explain the principles of the present application. It is obvious that the drawings described below are merely some embodiments of the present application, and those skilled in the art can obtain other drawings based on these drawings without any inventive effort. In the drawings:

FIG. 1 is a functional block diagram of a gain-dependent DC offset calibration circuit according to an embodiment of the present application.

FIG. 2 is a schematic storage structure of a calibration codeword and a link sequence according to an embodiment of the present application.

FIG. 3 is a circuit diagram of an accumulator according to an embodiment of the present application.

FIG. 4 is a gain-dependent DC offset calibration method according to an embodiment of the present application.

### DESCRIPTION OF EMBODIMENTS

The following specific examples illustrate the implementation of the present application. Those skilled in the art can easily understand other advantages and effects of the present application from the content disclosed in this specification. The present application can also be implemented or applied through other different specific embodiments, and various details in this specification can also be modified or changed based on different viewpoints and applications without departing from the spirit of the present application. It should be noted that, unless otherwise specified, the following embodiments and features in the embodiments can be combined with each other.

It should be noted that the illustrations provided in the following embodiments are only schematic representations of the basic concept of the present application. Therefore, the drawings only show the components related to the present application and are not drawn according to the actual number, shape and size of the components in the actual implementation. In the actual implementation, the form, quantity and scale of each component can be arbitrarily changed, and the layout of the components may also be more complex.

Although the terms “first,” “second,” “A,” and “B,” etc., may be used herein to describe various elements, these elements should not be limited by these terms and are used only to distinguish one element from another. For example, without departing from the scope of the art described below, a first element may be referred to as a second element, and similarly, a second element may be referred to as a first element. The term “and/or” includes a combination of multiple related items or any one of multiple related items.

As used herein, unless the context otherwise indicates, the singular form is also intended to include the plural form, and it will be understood that the term “comprising” means the presence of the stated feature, quantity, step, operation, element, or combination thereof, but does not exclude the presence or addition of one or more other features, quantities, steps, operations, elements, components, or combinations thereof.

Before proceeding with the detailed description, it is intended to clarify that the division of components in this specification is based solely on the primary function of each component. That is, two or more components described below may be combined into one component, or may be divided into two or more components based on more detailed functions. In addition to the primary functions of each component, each component described below may also perform some or all of the functions of other components, and some of the primary functions of each component may be performed specifically by other components.

When implementing the receiver signal link using semiconductor technology, non-ideal factors such as the signal path between the mixer's local oscillator port and RF port during physical implementation result in a certain amount of DC signal in the received signal. The presence of a DC signal reduces the effective input range of the analog-to-digital converter (ADC) input, affecting receiver performance. When the DC signal is too large, it can even affect the normal operation of the signal receiving channel.

To overcome the performance degradation caused by DC offset, different offset calibration circuits have been proposed in various literature. Generally, DC offset calibration circuits can be divided into foreground calibration and background calibration. The foreground calibration circuit starts before the zero-IF receiver operates to calibrate the circuit; while the background calibration circuit calibrates the DC offset while the zero-IF receiver is operating normally. Each of the foreground calibration and the background calibration has its advantages and disadvantages. The foreground calibration operates before the circuit is working normally, but it cannot adapt to changes in the zero-IF receiver's PVT parameters when the zero-IF receiver's PVT parameters change. The background calibration can adapt to parameter changes, but it has a longer calibration time and affects the normal operating state of the circuit. Neither front-end nor background calibration considers changes in receiver gain. However, as the wireless signal changes, the receiver channel gain usually changes with the signal amplitude.

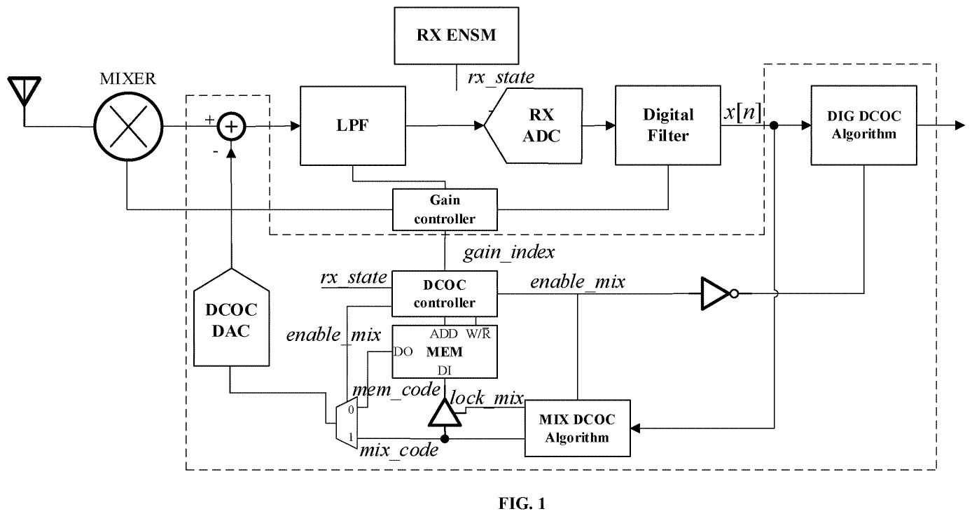

To address the issue of neglecting receiver gain variations when addressing DC offset through foreground and background calibration, the present application provides a fast gain-dependent mix DC offset calibration circuit. FIG. 1 shows a functional block diagram of a zero-IF receiver and the proposed DC offset calibration circuit. The portion within the dashed box represents the proposed DC offset calibration circuit, while the area outside the dashed box is the main signal path of the zero-IF receiver. The main signal path of the zero-IF receiver and the DC offset circuit operate in unison under the coordination of the receiver state controller (RX ENSM). The calibration process is broadly divided into two stages: foreground calibration and background calibration. The foreground calibration provides the initial calibration point for the background calibration.

The present application provides a gain-dependent DC offset calibration circuit applied to a zero-IF receiver. The zero-IF receiver includes: a mixer, a low-pass filter (LPF), an ADC, a digital filter, a gain controller, and a state controller. During normal operation of the circuit, the RF signal passes through the antenna and the mixer and is transformed into an analog baseband signal. Subsequently, after filtering by the analog LPF, the analog baseband signal enters the ADC. The ADC quantizes the analog baseband signal into a digital baseband signal, which then enters the digital filter and undergoes online DC offset calibration processing. The digital signal is then sent to a host computer. When the input wireless signal power changes, the link adjusts the signal gain under the control of the gain controller, thereby stabilizing the output signal amplitude within a set range; Referring to FIG. 1, the calibration circuit includes a DC offset calibration (DCOC) controller, a mix DCOC calibrator (MIX DCOC Algorithm), and a digital domain (DCOC calibrator (DIG DCOC Algorithm).

The DC offset calibration controller is configured to output a first control signal enable_mix based on the state information rx_state sent by the state controller of the zero-IF receiver, to start the mix DC offset calibrator.

The mix DC offset calibrator is configured to: when the first control signal enable_mix is at a first value, execute a mix DC offset calibration algorithm to perform mix DC offset calibration and obtain a calibration codeword.

The digital-domain DC offset calibrator is configured to: when the first control signal enable_mix is at a second value, execute a digital-domain DC offset calibration algorithm and perform digital-domain DC calibration according to the calibration codeword.

In some embodiments, when the chip is powered on, the state controller sends instructions to the gain controller and the DC offset calibration controller. The gain controller configures the channel gain in a certain order, which can be configured from largest to smallest, from smallest to largest, or in other settings, in tabular form. At the same time, the gain controller sends the current gain information to the DC offset calibration controller; the gain information includes: link gain A[i] and gain index gain_index[i]. If the gain configuration is not completed, the gain controller iterates through all gain combinations according to the set gain control method and sorts all the gains in a certain way, such as from largest to smallest or from smallest to largest. Let the link gain configured in the i-th time be A[i], and the corresponding sequence be gain_index[i]. After the gain configuration is completed, the gain controller sends the link gain A[i] and the corresponding gain index gain_index[i] to the DC offset calibration controller. The DC offset calibration controller receives the link gain A[i] and the gain index gain_index[i], and processes them in conjunction with the state information rx_state sent by the state controller. When rx_state is in a state of offline calibration, the DC offset calibration controller starts and executes the mix DC offset calibration algorithm.

It should be noted that for a mix DC offset calibrator, the first value can be “1” and the second value can be “0”.

In an embodiment, the DC offset calibration circuit further includes a DC offset calibration digital-to-analog converter (DAC); the mix DC offset calibrator is configured to output a codeword mix_code when the first control signal enable_mix is at a first value, and send the codeword mix_code to the DC offset calibration DAC; the DC offset calibration DAC is configured to convert the codeword mix_code from a digital codeword to an analog current; the analog current output by the DC offset calibration DAC is added to the output current of the mixer, the combined output current then passes through a low-pass filter, an ADC, and a digital filter, and a digital codeword is obtained; the mix DC offset calibrator performs DC value detection based on the digital codeword and generates a corresponding calibration codeword.

Specifically, the DC offset calibration controller outputs a first control signal enable_mix, when the first control signal enable_mix changes from 0 to 1, the mix DC offset calibration algorithm is executed. The first control signal enable_mix also serves as the selection signal for a two-to-one switch. When enable_mix is 1, the two-to-one switch selects the mix DC offset calibrator to output the codeword mix_code, which is then fed into the DC offset calibration DAC (DCOC DAC) to achieve the conversion from the digital codeword to an analog current. At this time, the output current of the DC offset calibration DAC is added to the mixer output, and after passing through a low-pass filter, ADC, and digital filter, the mixer output is fed back into the mix DC offset calibrator, forming a complete analog-digital mixed-signal calibration loop. The mix DC offset calibrator executes the mix DC offset calibration algorithm, detects the DC value based on the received digital codeword, and generates the corresponding calibration codeword mix_code to achieve DC calibration.

In an embodiment, the mix DC offset calibrator includes: a first-stage accumulation unit, a gain unit, and a second-stage accumulation unit.

The number of accumulated points in the first-stage accumulation unit is N_{A}, and the output signal Aᵢ of the gain unit is:

$${A}_{i} = {k}_{a t t} {\sum }_{n = 1}^{{N}_{A}} {x}_{i} [ n ] , \qquad ( 1 )$$

where kₐₜₜ is the gain of the gain unit, and xᵢ[n] represents the i-th accumulation interval of the signal x[n] output by the digital filter. The DC offset value of the signal does not change within the accumulation interval. The signal x[n] is expressed as:

$$x [ n ] = a sin ( 2 π fn ) + d , \qquad ( 2 )$$

where a represents the signal amplitude, f represents the signal frequency, and d is the DC component of the signal.

In the i-th accumulation interval, the signal xᵢ[n] is,

$${x}_{i} [ n ] = {a}_{i} sin ( 2 π fn ) + d - {k}_{conv} {d}_{comp , i} = {a}_{i} sin ( 2 π fn ) + {d}_{i} , \qquad ( 3 )$$

where aᵢ represents the signal amplitude, d_{comp,i} represents the calibration codeword, and k_{conv} is the gain coefficient.

The output value Aᵢ of the gain unit is the current DC offset value of the signal:

$${A}_{i} = {k}_{a t t} \times {\sum }_{n = 1}^{{N}_{A}} {x}_{i} [ n ] \approx {k}_{a t t} {d}_{i} {N}_{A} , \qquad ( 4 )$$

The second-stage accumulation unit receives the output value Aᵢ from the gain unit and obtains the next update value d_{comp,i+1}:

$${d}_{comp , i + 1} = {d}_{comp , i} + {k}_{a t t} {d}_{i} {N}_{A} , \qquad ( 5 )$$

Substituting dᵢ=d−k_{conv}×d_{comp,i} into the above equation, we get:

$${d}_{comp , i + 1} = {d}_{c o m p , i} + {k}_{att} {N}_{A} ( d - {k}_{c o n v} {d}_{comp , i} ) = {k}_{att} {N}_{A} d + ( 1 - {k}_{c o n v} {k}_{att} {N}_{A} ) {d}_{comp , i} = A + k {d}_{c o m p , i} , \qquad ( 6 )$$

$$\begin{matrix}k = 1 - {k}_{c o n v} {k}_{a t t} {N}_{A} \\ A = {k}_{a t t} {N}_{A} d\end{matrix} , \qquad ( 7 )$$

Equation (7) reduces or eliminates the DC offset value in the signal after multiple iterations.

Specifically, the mix DC offset calibrator includes the following steps during calibration.

Let the signal output from the digital filter be x[n]. After entering the offset calibration algorithm, the signal x[n] is first accumulated to estimate the DC value of the current signal. In implementation, the accumulator may include: a first-stage accumulator unit including an adder and a delay unit; a gain unit; and a second-stage accumulator unit including an adder and a delay unit. Let the number of accumulated data points in the first-stage accumulator unit be N_{A}. In implementation, the number of accumulated points N_{A} is usually programmable online.

To adjust the closed-loop control loop gain, a gain unit is introduced after the output of the first-stage accumulator. Let the gain be kₐₜₜ, then the output signal Aᵢ after the gain unit is:

$${A}_{i} = {k}_{att} {\sum }_{n - 1}^{{N}_{A}} {x}_{i} [ n ] , \qquad ( 1 )$$

where xᵢ[n] represents the i-th accumulation interval of signal x[n], and assume that the DC offset value of the signal does not change within this accumulation interval. Assume that signal x[n] can be represented as:

$$x [ n ] = a sin ( 2 π fn ) + d , \qquad ( 2 )$$

where a represents the signal amplitude, f represents the signal frequency, and d is the DC component of the signal. Since the DC value being compensated changes during the DC offset compensation process, the DC value d also changes with time. Let the output value of the DC offset compensation algorithm be d_{comp,i} (d_{comp,i} is the calibration codeword mix_code in FIG. 1, which is replaced by d_{comp,i} for simplicity in the following equations), and let the conversion gain coefficient from the calibration codeword through the DAC to the ADC input be k_{conv}. Let the signal be xᵢ[n], then:

$${x}_{i} [ n ] = {a}_{i} sin ( 2 π fn ) + d - {k}_{conv} {d}_{comp , i} = {a}_{i} sin ( 2 π rfn ) + {d}_{i} , \qquad ( 3 )$$

At this time, the output value Aᵢ of the gain unit is the current DC offset value of the signal, which can be expressed as:

$${A}_{i} = {k}_{att} \times {\sum }_{n = 1}^{{N}_{A}} {x}_{i} [ n ] \approx {k}_{att} {d}_{i} {N}_{A} , \qquad ( 4 )$$

After the DC offset value Aᵢ is obtained, it is sent to the first-stage accumulation unit to obtain the next update value d_{comp,i+1}:

$${d}_{comp , i + 1} = {d}_{comp , i} + {k}_{att} {d}_{i} {N}_{A} , \qquad ( 5 )$$

Substituting dᵢ=d−k_{conv}×d_{comp,i} into the above equation, we get:

$$\begin{matrix}{d}_{comp , i + 1} = {d}_{comp , i} + {k}_{att} {N}_{A} ( d - {k}_{conv} {d}_{comp , i} ) \\ = {k}_{att} {N}_{a} d + ( 1 - {k}_{conv} {k}_{att} {N}_{A} ) {d}_{comp , i} \\ = A + {kd}_{comp , i}\end{matrix} , \qquad ( 6 )$$

$$where :$$

$$\begin{matrix}k = 1 - {k}_{conv} {k}_{att} {N}_{A} \\ A = {k}_{att} {N}_{A} d\end{matrix} , \qquad ( 7 )$$

Equation (7) can reduce or eliminate the DC offset value in the signal after multiple iterations. Typically, the number of iterations is programmable in software. When the number of iterations exceeds a preset value, the mixed-signal DC offset calibration algorithm converges, changing the lock_mix signal from 0 to 1.

In an embodiment, during the mix DC calibration process, the mix DC offset calibrator outputs a second control signal lock_mix to indicate whether the mix DC calibration is complete.

When the second control signal lock_mix is at the first value, it is indicated that the mix DC calibration is complete.

When the second control signal lock_mix is at the second value, it is indicated that the mix DC calibration has not been completed.

It should be noted that for a mix DC offset calibrator, the first value can be “1” and the second value can be “0”.

As the algorithm iterates, the calibration codeword mix_code tends to converge. During the calibration process, the mix DC offset calibrator outputs a second control signal lock_mix to indicate whether the algorithm has converged. When the mix DC offset calibration is not complete, the second control signal lock_mix remains 0; the entire process waits for the algorithm to converge. When the algorithm converges, the second control signal lock_mix changes from 0 to 1, indicating that the mix DC offset calibration for the current gain configuration A[i] is complete, and the process proceeds to the next step.

In an embodiment, the calibration circuit further includes: a memory (MEM) configured to store the calibration codeword and the link sequence gain_index[i] configured by the gain controller of the zero-IF receiver as an association.

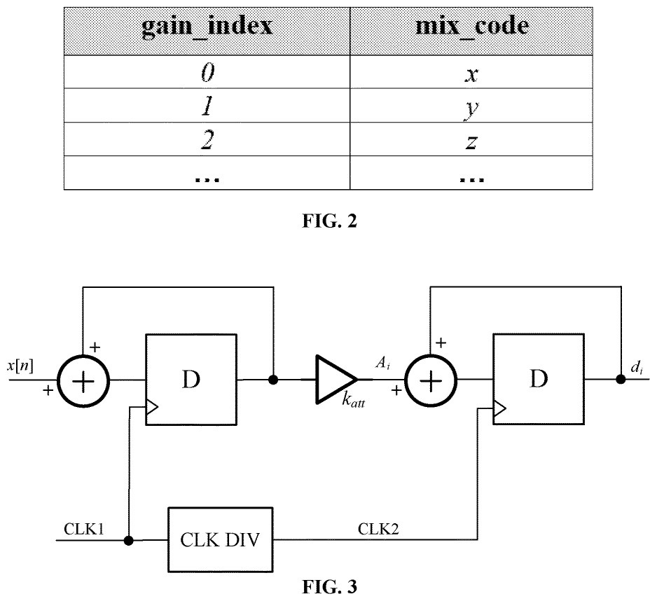

Specifically, the calibration codeword mix_code is sent to both the DC offset calibration DAC and a gating circuit. The second control signal lock_mix also serves as the control signal for the gating circuit. When the second control signal lock_mix changes from 0 to 1, the gating circuit turns on. The calibration codeword mix_code obtained from the mix DC offset calibrator is sent to the data input terminal of the memory, forming a storage table with the link sequence gain_index[i]. The link sequence gain_index[i] serves as the row number of the storage table, and the calibration codeword mix_code serves as the storage content of the corresponding row. FIG. 2 shows a schematic storage structure of the calibration codeword and the link sequence. In implementation, those skilled in the art can design other memory structures, but this does not affect the scheme proposed in the present application. For example, on-chip memory can be implemented in different ways, such as SRAM (Static Random-Access Memory), ROM (Read-Only Memory), OTP (One Time Programmable), FLASH (flash memory), etc.

After the calibration codeword mix_code is stored, the gain is configured, and then the calibration is completed.

After iterating through all possible gain values, the gain controller sends an indication signal to the state controller, indicating that the DC offset has been calibrated offline under all gain conditions. Upon receiving the indication signal, the state controller changes the state of rx_state from off_calibration state to normal_work state.

After receiving the rx_state signal as being in the normal_work state, the DC offset calibration controller switches the calibration mode from offline calibration mode to normal receiving mode. At this time, the DC offset calibration controller changes the first control signal enable_mix from 1 to 0. When the first control signal enable_mix is 0, the mix DC offset calibrator is turned off, and the digital-domain DC offset calibrator is turned on. During normal operation, the DC offset calibration controller receives the current link gain A[i] and gain index gain_index[i] from the gain controller. The DC offset calibration controller retrieves the corresponding calibration codeword mix_code from memory according to the input gain index gain_index[i]. Under the control of the first control signal enable_mix, the two-to-one selector connected to the input of the DC offset calibration DAC selects the calibration codeword mix_code as the output and sends it into the DC offset calibration DAC. The DC offset calibration DAC then converts the calibration codeword mix_code from a digital codeword to an analog current and adds the analog current to the output current of the mixer. After the output current of the mixer passes through a low-pass filter, an ADC, and a digital filter, a digital codeword is obtained. The digital-domain DC offset calibrator detects the DC value based on the digital codeword and generates the corresponding calibration codeword to complete the DC calibration.

The above process relies on a mix DC offset calibration algorithm and a digital-domain DC offset calibration algorithm. Algorithmically, the mix DC offset calibration algorithm and the digital-domain DC offset calibration algorithm are the same. Compared with the digital-domain DC offset algorithm, the mix DC offset algorithm involves an additional conversion process from digital domain to analog domain and then back to digital domain.

For the digital-domain DC offset calibration algorithm, k_{conv} in equation (7) can be directly set to 1, and the calibration method is the same as the mix DC offset calibration method.

In mix DC offset calibration, the signal passes through a mixer, a low-pass filter, an ADC, a digital filter, etc.; therefore, a time set for waiting for the analog RF circuit to stabilize can be provided before each accumulation. In digital-domain DC offset calibration algorithms, this stabilization time can be accurately set based on the system's implementation delay.

Compared with traditional DC offset calibration circuits, the method proposed in the present application has the advantages of fast calibration speed, high calibration accuracy, and insensitivity of calibration accuracy and speed to changes in receiver gain.

The present application provides a zero-IF receiver, including a mixer, a low-pass filter, an ADC, a digital filter, a gain controller, and a state controller; the zero-IF receiver also includes the aforementioned DC offset calibration circuit.

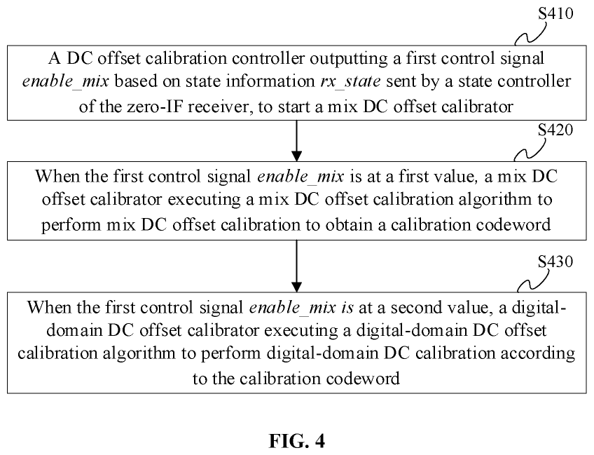

Referring to FIG. 4, the present application provides a gain-dependent DC offset calibration method applied to a zero-IF receiver, which includes a gain controller and a state controller; the calibration method includes the following steps.

In step S410: the DC offset calibration controller outputs the first control signal enable_mix based on the state information rx_state sent by the state controller of the zero-IF receiver to start the mix DC offset calibrator.

In step S420: when the first control signal enable_mix is at a first value, the mix DC offset calibrator executes the mix DC offset calibration algorithm to perform mix DC offset calibration and obtain the calibration codeword.

In step S430: when the first control signal enable_mix signal is at a second value, the digital-domain DC offset calibrator executes the digital-domain DC offset calibration algorithm and performs digital-domain DC calibration according to the calibration codeword.

In an embodiment, the step of executing a mix DC offset calibration algorithm to perform mix DC offset calibration and obtain calibration codewords when the first control signal enable_mix signal is at the first value includes the following steps.

When the first control signal enable_mix is at the first value, the mix DC offset calibrator outputs a codeword mix_code, and the codeword mix_code is sent to the DC offset calibration DAC.

The DC offset calibration DAC converts the codeword mix_code from a digital codeword to an analog current, adds the analog current to the output current of the mixer, the output current then passes through a low-pass filter, an ADC and a digital filter, and the digital codeword is obtained.

The mix DC offset calibrator detects the DC value based on the digital codeword and generates the corresponding calibration codeword.

In an embodiment, the calibration method further includes: storing the calibration codeword and the link sequence gain_index[i] configured by the gain controller of the zero-IF receiver as an association.

In an embodiment of the present application, the mix DC offset calibrator includes: a first-stage accumulation unit, a gain unit, and a second-stage accumulation unit; the mix DC offset calibrator performs DC value detection based on the digital codeword and generates a corresponding calibration codeword, including the following steps.

The number of accumulated points in the first-stage accumulation unit is N_{A}, and the output signal Aᵢ of the gain unit is:

$${A}_{i} = {k}_{att} {\sum }_{n = 1}^{{N}_{A}} {x}_{i} [ n ] , \qquad ( 1 )$$

where kₐₜₜ is the gain of the gain unit, xᵢ[n] represents the i-th accumulation interval of the signal x[n] output by the digital filter. The DC offset value of the signal does not change within the accumulation interval. The signal x[n] is expressed as:

$$x [ n ] = a sin ( 2 π fn ) + d , \qquad ( 2 )$$

where a represents the signal amplitude, f represents the signal frequency, and d is the DC component of the signal;

In the i-th accumulation interval, the signal xᵢ[n] is,

$${x}_{i} [ n ] = {a}_{i} sin ( 2 π fn ) + d - {k}_{conv} {d}_{comp , i} = {a}_{i} sin ( 2 π fn ) + {d}_{i} , \qquad ( 3 )$$

where aᵢ represents the signal amplitude, d_{comp,i} represents the calibration codeword, and k_{conv} is the gain coefficient.

The output value Aᵢ of the gain unit is the current DC offset value of the signal:

$${A}_{i} = {k}_{att} \times {\sum }_{n = 1}^{{N}_{A}} {x}_{i} [ n ] \approx {k}_{att} {d}_{i} {N}_{A} , \qquad ( 4 )$$

The second-stage accumulation unit receives the output value Aᵢ from the gain unit and obtains the next update value d_{comp, i}+1.

$${d}_{comp , i + 1} = {d}_{comp , i} + {k}_{att} {d}_{i} {N}_{A} , \qquad ( 5 )$$

Substituting dᵢ=d−k_{conv}×d_{comp,i} into the above equation, we get:

$$\begin{matrix}{d}_{comp , i + 1} = {d}_{comp , i} + {k}_{att} {N}_{A} ( d - {k}_{conv} {d}_{comp , i} ) \\ = {k}_{att} {N}_{a} d + ( 1 - {k}_{conv} {k}_{att} {N}_{A} ) {d}_{comp , i} \\ = A + {kd}_{comp , i}\end{matrix} , \qquad ( 6 )$$

$$wherein :$$

$$\begin{matrix}k = 1 - {k}_{conv} {k}_{att} {N}_{A} \\ A = {k}_{att} {N}_{A} d\end{matrix} , \qquad ( 7 )$$

Equation (7) reduces or eliminates the DC offset value in the signal after multiple iterations.

Specifically, the calibration method in the present application embodiment includes the following steps.

In step 1: when a chip powers on, a state controller sends an instruction to a gain controller and a DC offset calibration controller. The gain controller configures a channel gain in a specific order, which can be from largest to smallest, from smallest to largest, or in any other manner (in a tabular format). Simultaneously, the gain controller sends the current gain information to the DC offset controller.

In step 2: whether the gain configuration is complete is checked. If the gain configuration is not complete, the gain controller iterates through all gain combinations according to the set gain control method and sorts all the gains in a certain way, such as from largest to smallest or from smallest to largest. Let the link gain configured in the i-th time be A[i], and the corresponding sequence be gain_index[i]. After the gain configuration is complete, the gain controller sends the link gain A[i] and the corresponding index gain_index[i] to the DC offset calibration controller. The DC offset controller receives the link gain A[i] and the gain index gain_index[i] and processes them in conjunction with the state information rx_state sent by the state controller. When rx_state is in an offline calibration state, the DC offset calibration controller starts the mix DC offset calibration algorithm.

In step 3: the mix DC offset calibration algorithm is activated. In this stage, the DC offset controller outputs the first control signal enable_mix, which changes from 0 to 1, activating the mix DC offset calibrator and executing the mix DC offset calibration algorithm. The first control signal enable_mix also serves as the selection signal for a two-to-one switch; when the first control signal enable_mix is 1, the two-to-one switch selects the mix DC offset calibration algorithm output codeword mix_code, and sends this codeword mix_code to the DC offset calibration DAC (DCOC DAC) to achieve the conversion from digital codeword to analog current. At this time, the output current of the DC offset calibration DAC is added to the mixer output, and after the mixer output passes through a low-pass filter, an ADC, and a digital filter, it is sent back to the mix DC offset calibrator, forming a complete digital-analog mixed calibration loop. The mix DC offset calibrator performs DC value detection based on the received digital codeword and generates the corresponding calibration codeword mix_code to achieve DC calibration.

As the algorithm iterates, the calibration codeword mix_code tends to converge. During the calibration process, the mix DC offset calibration algorithm outputs a second control signal lock_mix to indicate whether the algorithm has converged. When the mix DC offset calibration is not complete, the second control signal lock_mix remains 0; the entire process waits for the algorithm to converge. When the algorithm converges, the second control signal lock_mix changes from 0 to 1, indicating that the mix DC offset calibration for the current gain configuration A[i] is complete, and the process proceeds to the next step.

In step 4: the calibration value is stored. The calibration codeword mix_code is sent to both the DC offset calibration DAC and the gating circuit. The second control signal lock_mix also serves as the control signal for the gating circuit. When the second control signal lock_mix changes from 0 to 1, the gating circuit is turned on. The calibration codeword mix_code obtained from the mix DC offset calibrator is sent to the data input terminal of the memory, forming a storage table with the gain index gain_index[i]. The gain index gain_index[i] serves as the row number of the storage table, and the calibration codeword mix_code serves as the stored content of the corresponding row.

When storing the calibration codeword mix_code is completed, return to step 2.

In step 5: the mix DC offset calibration ends and it is to receive normal operation indication. After traversing all possible gain values, the gain controller sends an indication signal to the state controller, indicating that DC offset calibration has been completed offline for all gain conditions. Upon receiving the indication signal, the state controller changes the state of rx_state from off_calibration to normal_work.

In step 6: after receiving the rx_state signal as being in the normal_work state, the DC offset calibration controller switches the calibration mode from offline calibration mode to normal receiving mode. At this time, the DC offset calibration controller changes the first control signal enable_mix from 1 to 0. When the first control signal enable_mix is 0, the mix DC offset calibrator is turned off, and the digital-domain DC offset calibrator is turned on to execute the digital-domain DC offset calibration algorithm. During normal operation, the DC offset calibration controller receives the current gain information and corresponding gain index from the gain controller. Based on the input gain index, the DC offset calibration controller retrieves the corresponding calibration codeword mix_code stored in the memory. Under the control of the first control signal enable_mix, the two-to-one selector connected to the input of the DC offset calibration DAC selects the calibration codeword mix_code as the output and sends mix_code into the DC offset calibration DAC.

The above process relies on a mix DC offset calibration algorithm and a digital-domain DC offset calibration algorithm. Algorithmically, mix DC offset calibration and digital-domain DC offset calibration are the same. Compared with the digital-domain DC offset algorithm, the mix DC offset algorithm involves an additional conversion process from digital domain to analog domain and then back to digital domain. Therefore, in the present application, the mix DC offset calibration algorithm is used as an example to describe its working process.

The beneficial effects of the present application are as follows.

The present application discloses a gain-dependent DC offset calibration circuit applied to a zero-IF receiver. The calibration circuit includes a DC offset calibration controller, a mix DC offset calibrator, and a digital-domain DC offset calibrator. The DC offset calibration controller is configured to output a first control signal enable_mix based on state information rx_state sent by a state controller of the zero-IF receiver to activate the mix DC offset calibrator. The mix DC offset calibrator is configured to execute a mix DC offset calibration algorithm when the first control signal enable_mix is at a first value, to perform mix DC offset calibration and obtain a calibration codeword. The digital-domain DC offset calibrator is configured to execute a digital-domain DC offset calibration algorithm when the first control signal enable_mix is at a second value, to perform digital-domain DC calibration based on the calibration codeword. Compared with traditional DC offset calibration methods, the method proposed in the present application has the advantages of fast calibration speed, high calibration accuracy, insensitivity to changes in receiver gain for both accuracy and speed of the calibration, and the like.

The above embodiments are merely illustrative of the principles and effects of the present application and are not intended to limit the present application. Any person skilled in the art can modify or alter the above embodiments without departing from the spirit and scope of the present application. Therefore, all equivalent modifications or alterations made by those skilled in the art without departing from the spirit and technical concept disclosed in the present application should still be covered by the claims of the present application.

What is claimed is:

1. A gain-dependent DC offset calibration circuit, applied to a zero-IF receiver, comprising:
a DC offset calibration controller, configured to output a first control signal enable_mix based on state information rx_state sent by a state controller of the zero-IF receiver;
a mix DC offset calibrator, configured to be started by the first control signal enable_mix and execute a mix DC offset calibration algorithm to perform mix DC offset calibration when the first control signal enable_mix is at a first value, to obtain a calibration codeword; and
a digital-domain DC offset calibrator, configured to execute a digital-domain DC offset calibration algorithm when the first control signal enable_mix is at a second value, and perform digital-domain DC calibration according to the calibration codeword.

2. The gain-dependent DC offset calibration circuit according to claim 1, further comprising a DC offset calibration DAC, wherein:
the mix DC offset calibrator is configured to output a codeword mix_code when the first control signal enable_mix is at the first value, and send the codeword mix_code into the DC offset calibration DAC;
the DC offset calibration DAC is configured to convert the codeword mix_code from a digital codeword to an analog current, wherein the analog current output by the DC offset calibration DAC is added to an output current of a mixer, and a digital codeword is obtained after the combined output current passes through a low-pass filter, an ADC, and a digital filter; and
the mix DC offset calibrator detects a DC value based on the digital codeword and generates a corresponding calibration codeword.

3. The gain-dependent DC offset calibration circuit according to claim 2, further comprising:
a memory configured to store the calibration codeword and a link sequence gain_index[i] configured by a gain controller of the zero-IF receiver as an association.

4. The gain-dependent DC offset calibration circuit according to claim 3, wherein, during mix DC calibration, the mix DC offset calibrator outputs a second control signal lock_mix to indicate whether the mix DC calibration is completed, wherein:
when the second control signal lock_mix is at the first value, it is indicated that the mix DC calibration is complete; and
when the second control signal lock_mix is at the second value, it is indicated that the mix DC calibration has not been completed.

5. The gain-dependent DC offset calibration circuit according to claim 2, wherein the mix DC offset calibrator comprises: a first-stage accumulation unit; a gain unit; and a second-stage accumulation unit, wherein:
the number of accumulated points in the first-stage accumulation unit is N_{A}, and an output signal Aᵢ of the gain unit is:
$${A}_{i} = {k}_{att} {\sum }_{n = 1}^{{N}_{A}} {x}_{i} [ n ] , \qquad ( 1 )$$
where kₐₜₜ is a gain of the gain unit, xᵢ[n] represents an i-th accumulation interval of a signal x[n] output by the digital filter,
a DC offset value of the signal does not change within the accumulation interval, and the signal x[n] is expressed as:
$$x [ n ] = a sin ( 2 π fn ) + d , \qquad ( 2 )$$
where a represents signal amplitude, f represents signal frequency, and d is a DC component of the signal;
in the i-th accumulation interval, the signal xᵢ[n] is:
$${x}_{i} [ n ] = {a}_{i} sin ( 2 π fn ) + d - {k}_{conv} {d}_{comp , i} = {a}_{i} sin ( 2 π fn ) + {d}_{i} , \qquad ( 3 )$$
where aᵢ represents signal amplitude, d_{comp, i} represents the calibration codeword, and k_{conv} is a gain coefficient;
the output value Aᵢ of the gain unit is a current DC offset value of the signal:
$${A}_{i} = {k}_{att} \times {\sum }_{n = 1}^{{N}_{A}} {x}_{i} [ n ] \approx {k}_{att} {d}_{i} {N}_{A} , \qquad ( 4 )$$
the second-stage accumulation unit receives the output value Aᵢ from the gain unit and obtains a next update value d_{comp,i+1}:
$${d}_{comp , i + 1} = {d}_{comp , i} + {k}_{att} {d}_{i} {N}_{A} \qquad ( 5 )$$
substituting dᵢ=d−k_{conv}×d_{comp,i} into the above equation (5) to get:
$$\begin{matrix}{d}_{comp , i + 1} = {d}_{comp , i} + {k}_{att} {N}_{A} ( d - {k}_{conv} {d}_{comp , i} ) \\ = {k}_{att} {N}_{A} d + ( 1 - {k}_{conv} {k}_{att} {N}_{A} ) {d}_{comp , i} \\ = A + {kd}_{comp , i}\end{matrix} , \qquad ( 6 )$$
$$where :$$
$$\begin{matrix}k = 1 - {k}_{conv} {k}_{att} {N}_{A} \\ A = {k}_{att} {N}_{A} d\end{matrix} , \qquad ( 7 )$$
wherein equation (7) reduces or eliminates the DC offset value in the signal after multiple iterations.

6. A gain-dependent DC offset calibration method, applied to a zero-IF receiver, wherein the zero-IF receiver comprising a gain controller and a state controller, and the gain-dependent DC offset calibration method comprises:
outputting, via a DC offset calibration controller, a first control signal enable_mix based on state information rx_state sent by the state controller of the zero-IF receiver, to start a mix DC offset calibrator;
determining that the first control signal enable_mix is at a first value, and executing, by a mix DC offset calibrator, a mix DC offset calibration algorithm upon determining that the first control signal enable_mix is at the first value to perform mix DC offset calibration to obtain a calibration codeword; and
determining that the first control signal enable_mix is at a second value, and executing, by a digital-domain DC offset calibrator, a digital-domain DC offset calibration algorithm upon determining that the first control signal enable_mix is at the second value to perform digital-domain DC calibration according to the calibration codeword.

7. The gain-dependent DC offset calibration method according to claim 6, wherein executing the mix DC offset calibration algorithm to perform mix DC offset calibration to obtain the calibration codeword includes:
determining that the first control signal enable_mix is at the first value, and the mix DC offset calibrator outputting a codeword mix_code and sending the codeword mix_code to a DC offset calibration DAC upon determining that the first control signal enable_mix is at the first value;
converting, by the DC offset calibration DAC, the codeword mix_code from a digital codeword to an analog current; adding, by the DC offset calibration DAC, the analog current to an output current of a mixer; and obtaining a digital codeword after the combined output current passes through a low-pass filter, an ADC and a digital filter; and
the mix DC offset calibrator detecting a DC value based on the digital codeword and generating a corresponding calibration codeword.

8. The gain-dependent DC offset calibration method according to claim 7, further comprising:
storing the calibration codeword and a link sequence gain_index[/] configured by the gain controller of the zero-IF receiver as an association.

9. The gain-dependent DC offset calibration method according to claim 7, wherein the mix DC offset calibrator comprises: a first-stage accumulation unit, a gain unit, and a second-stage accumulation unit; the mix DC offset calibrator detecting the DC value based on the digital codeword and generating the corresponding calibration codeword includes:
the number of accumulated points in the first-stage accumulation unit being N_{A}, and an output signal Aᵢ of the gain unit being:
$${A}_{i} = {k}_{att} {\sum }_{n = 1}^{{N}_{A}} {x}_{i} [ n ] \qquad ( 1 )$$
where kₐₜₜ is a gain of the gain unit, xᵢ[n] represents an i-th accumulation interval of a signal x[n] output by the digital filter;
assuming that a DC offset value of the signal does not change within the accumulation interval, and the signal x[n] being expressed as:
$$x [ n ] = a sin ( 2 π fn ) + d \qquad ( 2 )$$
where a represents signal amplitude, f represents signal frequency, and d is a DC component of the signal;
in the i-th accumulation interval, the signal xᵢ[n] being:
$${x}_{i} [ n ] = {a}_{i} sin ( 2 π fn ) + d - {k}_{conv} {d}_{comp , i} = {a}_{i} sin ( 2 π fn ) + {d}_{i} \qquad ( 3 )$$
where aᵢ represents signal amplitude, d_{comp, i} represents the calibration codeword, and k_{conv} is a gain coefficient;
the output value Aᵢ of the gain unit being a current DC offset value of the signal:
$${A}_{i} = {k}_{att} \times {\sum }_{n = 1}^{{N}_{A}} {x}_{i} [ n ] \approx {k}_{att} {d}_{i} {N}_{A} \qquad ( 4 )$$
the second-stage accumulation unit receiving the output value Aᵢ from the gain unit and obtaining a next update value d_{comp,i+1}:
$${d}_{comp , i + 1} = {d}_{comp , i} + {k}_{att} {d}_{i} {N}_{A} \qquad ( 5 )$$
substituting dᵢ=d−k_{conv}×d_{comp,i} into the above equation (5) to get:
$$\begin{matrix}{d}_{comp , i + 1} = {d}_{comp , i} + {k}_{att} {N}_{A} ( d - {k}_{conv} {d}_{comp , i} ) \\ = {k}_{att} {N}_{A} d + ( 1 - {k}_{conv} {k}_{att} {N}_{A} ) {d}_{comp , i} \\ = A + {kd}_{comp , i}\end{matrix} , \qquad ( 6 )$$
$$where :$$
$$\begin{matrix}k = 1 - {k}_{conv} {k}_{att} {N}_{A} \\ A = {k}_{att} {N}_{A} d\end{matrix} , \qquad ( 7 )$$
equation (7) reducing or eliminating the DC offset value in the signal after multiple iterations.

10. A zero-IF receiver, comprising: a mixer, a low-pass filter, an ADC, a digital filter, a gain controller, and a state controller, wherein the zero-IF receiver further comprises a gain-dependent DC offset calibration circuit applied to the zero-IF receiver, and the gain-dependent DC offset calibration circuit comprises: a DC offset calibration controller, a mix DC offset calibrator, and a digital-domain DC offset calibrator, wherein:
the DC offset calibration controller is configured to output a first control signal enable_mix based on state information rx_state sent by a state controller of the zero-IF receiver, to start the mix DC offset calibrator;
the mix DC offset calibrator is configured to execute a mix DC offset calibration algorithm to perform mix DC offset calibration when the first control signal enable_mix is at a first value, to obtain a calibration codeword; and
the digital-domain DC offset calibrator is configured to execute a digital-domain DC offset calibration algorithm when the first control signal enable_mix is at a second value, and perform digital-domain DC calibration according to the calibration codeword.

11. The zero-IF receiver according to claim 10, further comprising a DC offset calibration DAC, wherein:
the mix DC offset calibrator is configured to output a codeword mix_code when the first control signal enable_mix is at the first value, and send the codeword mix_code into the DC offset calibration DAC;
the DC offset calibration DAC is configured to convert the codeword mix_code from a digital codeword to an analog current, wherein the analog current output by the DC offset calibration DAC is added to an output current of the mixer, and a digital codeword is obtained after the combined output current passes through the low-pass filter, the ADC, and the digital filter; and
the mix DC offset calibrator detects a DC value based on the digital codeword and generates a corresponding calibration codeword.

12. The zero-IF receiver according to claim 11, wherein the DC offset calibration circuit further comprises:
a memory configured to store the calibration codeword and a link sequence gain_index[i] configured by a gain controller of the zero-IF receiver as an association.

13. The zero-IF receiver according to claim 12, wherein, during mix DC calibration, the mix DC offset calibrator outputs a second control signal lock_mix to indicate whether the mix DC calibration is completed, wherein:
when the second control signal lock_mix is at the first value, it is indicated that the mix DC calibration is complete; and
when the second control signal lock_mix is at the second value, it is indicated that the mix DC calibration has not been completed.

14. The zero-IF receiver according to claim 11, wherein the mix DC offset calibrator comprises: a first-stage accumulation unit; a gain unit; and a second-stage accumulation unit, wherein:
the number of accumulated points in the first-stage accumulation unit is N_{A}, and an output signal Aᵢ of the gain unit is:
$${A}_{i} = {k}_{att} {\sum }_{n = 1}^{{N}_{A}} {x}_{i} [ n ] , \qquad ( 1 )$$
where kₐₜₜ is a gain of the gain unit, xᵢ[n] represents an i-th accumulation interval of a signal x[n] output by the digital filter,
a DC offset value of the signal does not change within the accumulation interval, and the signal x[n] is expressed as:
$$x [ n ] = a sin ( 2 π fn ) + d , \qquad ( 2 )$$
where a represents signal amplitude, f represents signal frequency, and d is a DC component of the signal;
in the i-th accumulation interval, the signal xᵢ[n] is:
$${x}_{i} [ n ] = {a}_{i} sin ( 2 π fn ) + d - {k}_{conv} {d}_{comp , i} = {a}_{i} sin ( 2 π fn ) + {d}_{i} , \qquad ( 3 )$$
where aᵢ represents signal amplitude, d_{comp, i} represents the calibration codeword, and k_{conv} is a gain coefficient;
the output value Aᵢ of the gain unit is a current DC offset value of the signal:
$${A}_{i} = {k}_{att} \times {\sum }_{n = 1}^{{N}_{A}} {x}_{i} [ n ] \approx {k}_{att} {d}_{i} {N}_{A} , \qquad ( 4 )$$
the second-stage accumulation unit receives the output value Aᵢ from the gain unit and obtains a next update value d_{comp,i+1}:
$${d}_{comp , i + 1} = {d}_{comp , i} + {k}_{att} {d}_{i} {N}_{A} \qquad ( 5 )$$
substituting dᵢ=d−k_{conv}×d_{comp,i} into the above equation (5) to get:
$$\begin{matrix}{d}_{comp , i + 1} = {d}_{comp , i} + {k}_{att} {N}_{A} ( d - {k}_{conv} {d}_{comp , i} ) \\ = {k}_{att} {N}_{A} d + ( 1 - {k}_{conv} {k}_{att} {N}_{A} ) {d}_{comp , i} \\ = A + {kd}_{comp , i}\end{matrix} , \qquad ( 6 )$$
$$where :$$
$$\begin{matrix}k = 1 - {k}_{conv} {k}_{att} {N}_{A} \\ A = {k}_{att} {N}_{A} d\end{matrix} , \qquad ( 7 )$$
wherein equation (7) reduces or eliminates the DC offset value in the signal after multiple iterations.
